(19) United States
(12) Patent Application Publication
(10) Pub. No.: US 2008/0075374 A1
(43) Pub. Date: Mar. 27, 2008

(54) Processing circuit and method for automatic detection and compensation of pixel defects

(75) Inventor: Yu-Chung Liu, Taipei City (TW)

Correspondence Address: GALLAGHER & LATHROP, A PROFESSIONAL CORPORATION, 601 CALIFORNIA ST, SUITE 1111, SAN FRANCISCO, CA, 94108, US

(73) Assignee: Mobien Corporation, Taipei City (TW)

(21) Appl. No.: 11/893,560

(22) Filed: Aug. 15, 2007

(30) Foreign Application Priority Data
Sep. 22, 2006 (TW) 095135153

(51) Int. Cl. G06K 9/36

(52) U.S. Cl. 382/238

(57) ABSTRACT

A processing circuit for automatic detection and compensation of pixel defects includes a reading unit, a data buffer module, and a calculating module. The reading unit reads pixel values of a predetermined number of pixels in sequence. The pixel values include a target pixel value and a pixel value group adjacent to the target pixel value. The data buffer module receives the pixel values outputted from the reading unit, and stores the same temporarily in a FIFO manner. The calculating module calculates and processes the target pixel value and the pixel value group from the data buffer module to generate a processing value. If the processing value is equal to the target pixel value, the latter is outputted. If the processing value is not equal to the target pixel value, the former is outputted. Thus, pixel defects can be immediately detected and compensated when outputting the pixel values.

### CROSS-REFERENCE TO RELATED APPLICATION

This application claims priority of Taiwanese Application No. 095135153, filed on Sep. 22, 2006.

### BACKGROUND OF THE INVENTION

1. Field of the Invention

The invention relates to a processing circuit and method for detecting and compensating pixel defects, more particularly to a processing circuit and method that can automatically detect and compensate pixel defects using only a small amount of buffer space.

2. Description of the Related Art

In a pixel value group of the same color scheme in an image sensor, if the pixel values of the pixels are compared, it can be observed that some specific pixels will have a larger difference with adjacent pixels and will exhibit no changes after a period of time. This is referred to as pixel defects.

A current method for processing a pixel defect in an image sensor is to store information recording the pixel defect, i.e., coordinate positions of the pixel defect, in the image sensor in advance. Thereafter, a comparison and correcting circuit is used to locate the position of the pixel defect, and an interpolation technique is employed to compensate the pixel defect at that position.

However, the positions that can be recorded in the aforesaid method are limited. Moreover, when a new pixel defect is generated, compensation cannot be conducted therefor. Besides, since the positions of the pixel defects in each image sensor are different, to record the positions of the pixel defects for compensation while complying with individual requirements is difficult, and is disadvantageous in terms of mass production.

### SUMMARY OF THE INVENTION

Therefore, an object of the present invention is to provide a processing circuit, which can process pixel defects using a small amount of buffer space.

Accordingly, the processing circuit for automatic detection and compensation of pixel defects of this invention includes a reading unit, a data buffer module, and a calculating module.

The reading unit reads pixel values of a predetermined number of pixels in sequence. The pixel values include a target pixel value and a pixel value group adjacent to the target pixel value. The data buffer module receives the pixel values outputted from the reading unit, and stores the same temporarily in a first-in-first-out (FIFO) manner. The calculating module calculates and processes the target pixel value and the pixel value group from the data buffer module to generate a processing value. If the processing value is equal to the target pixel value, the latter is outputted. Otherwise, the processing value is outputted.

Another object of the present invention is to provide a processing method for automatically detecting and compensating pixel defects.

The processing method for automatically detecting and compensating pixel defects of the present invention includes the following steps: (A) reading pixel values of a predetermined number of pixels in sequence; (B) storing temporarily the pixel values in a FIFO manner, the pixel values including a target pixel value and a pixel value group adjacent to the target pixel value; and (C) calculating and processing the target pixel value and the pixel value group to generate a processing value, the target pixel value being outputted if the processing value is equal to the target pixel value, the processing value being outputted if the processing value is not equal to the target pixel value.

In the processing circuit and method for automatic detection and compensation of pixel defects of the present invention, pixel values of a predetermined number of pixels are first stored, and the pixel values are divided into a target pixel target and a pixel value group adjacent to the target pixel value. By calculating and processing the target pixel value and the pixel value group, a processing value can be calculated. By further comparing the target pixel value and the processing value, it can be determined which one of the original pixel value of the target pixel and the processing value is to be outputted, thereby providing an effect of real-time defect detection and compensation. Thus, yield of image sensors in mass production can be considerably enhanced.

### BRIEF DESCRIPTION OF THE DRAWINGS

Other features and advantages of the present invention will become apparent in the following detailed description of the preferred embodiment with reference to the accompanying drawings, of which:

FIG. 1 is a system block diagram to illustrate a preferred embodiment of a processing circuit for automatic detection and compensation of pixel defects according to the invention;

FIG. 2 is a schematic diagram to illustrate a plurality of pixels of an image sensor of the preferred embodiment arranged in a Bayer pattern;

FIG. 3 is a schematic diagram to illustrate a row of nine pixels used as one processing unit in the preferred embodiment;

FIG. 4 is a circuit block diagram to illustrate components and computational flow of a calculating module of the preferred embodiment; and

FIG. 5 is a flowchart to illustrate a preferred embodiment of a processing method for automatically detecting and compensating pixel defects according to the present invention.

### DETAILED DESCRIPTION OF THE PREFERRED EMBODIMENT

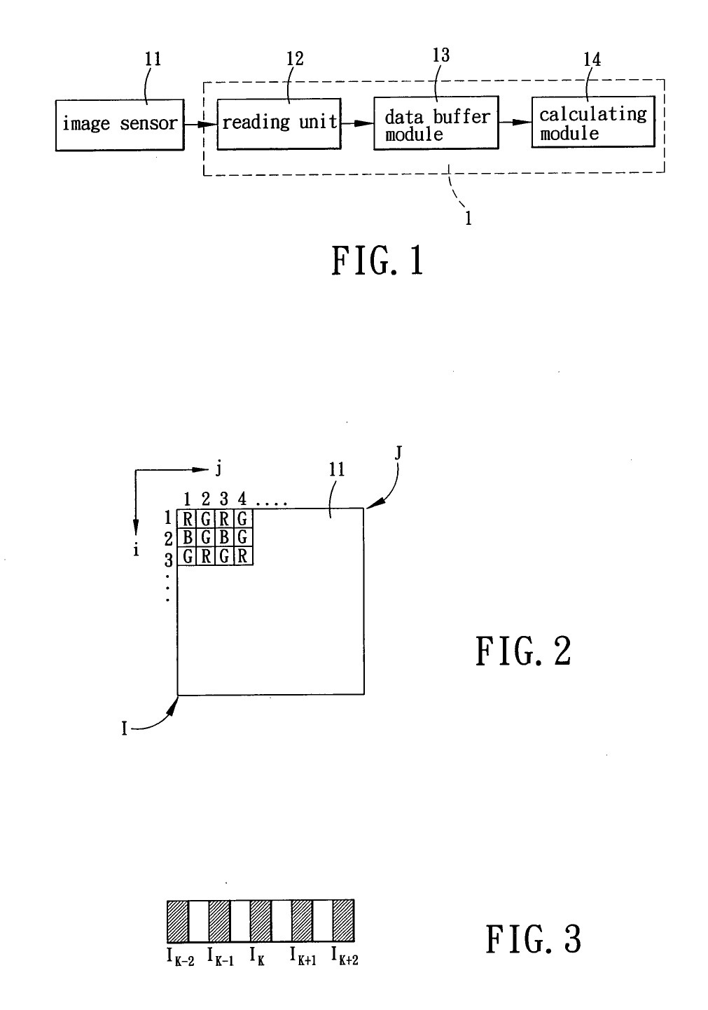

Referring to FIG. 1, the preferred embodiment of a processing circuit 1 that can automatically detect and compensate a pixel defect in an image sensor 11 is shown to include a reading unit 12, a data buffer module 13, and a calculating module 14.

Referring to FIGS. 1 and 2, the image sensor 11 is a matrix including a plurality of pixels. The pixels include red (R), green (G), and blue (B) pixels arranged in a Bayer pattern. The first row includes interleaved red (R) and green (G) pixels. The second row includes interleaved blue (B) and green (G) pixels. The third row includes interleaved green (G) and red (R) pixels. The arrangement of the remaining rows of pixels follows the same scheme.

Referring to FIG. 3, since the Bayer pattern has a regular interleaving characteristic, nine pixels in the same row are used as one processing unit in the present invention. Therefore, by storing a target pixel value and four points to the left of the target pixel value and four points to the right of the target pixel value, i.e., data of a total of nine points, pixel defect detection and compensation can be repeated on pixels of the same color scheme. To facilitate description, pixel values of the red (Rₖ), green (Gₖ) and blue (Bₖ) pixels to be processed will be referred to as Iₖ in the following description.

Of the nine pixels in the same row, Iₖ represents the pixel value of a pixel that requires defect detection and compensation. Iₖ₋₁ represents the pixel value of a pixel of the same color on the left side of and closest to the target pixel value Iₖ. Iₖ₋₂ represents the pixel value of a pixel of the same color on the left side of and closest to the pixel value Iₖ₋₁. Iₖ₊₁ represents the pixel value of a pixel of the same color on the right side of and closest to the target pixel value Iₖ. Iₖ₊₂ represents the pixel value of a pixel of the same color on the right side of and closest to the pixel value Iₖ₊₁.

The pixel values are divided into the target pixel value Iₖ and a pixel value group adjacent to the target pixel value Iₖ. The target pixel value Iₖ is the value of a pixel to be processed. The pixel value group includes the pixel values Iₖ₋₁ and Iₖ₋₂ on the left side of the target pixel value Iₖ, and the pixel values Iₖ₊₁ and Iₖ₊₂ on the right side of the target pixel value Iₖ.

Referring to FIG. 1, the reading unit 12 includes an amplifying circuit, an analog/digital converting circuit, and a clamping circuit, which are used to read a predetermined number of pixel values in sequence, which is nine in this embodiment. As this belongs to the prior art, a detailed description is omitted herein for the sake of brevity.

The data buffer module 13, which is coupled to the reading unit 12, correspondingly and temporarily stores the nine pixel values outputted by the reading unit 12. That is, the data buffer module 13 receives the nine pixel values outputted by the reading unit 12, and stores temporarily the nine pixel values in a first-in-first-out (FIFO) manner.

The calculating module 14, which is coupled to the data buffer module 13, is used to compare and calculate the pixel values, and processes the target pixel value Iₖ and the pixel value group provided by the data buffer module 13 to generate a processing value. If the processing value is equal to the target pixel value Iₖ, the latter is outputted. If the processing value is not equal to the target pixel value Iₖ, the former is outputted.

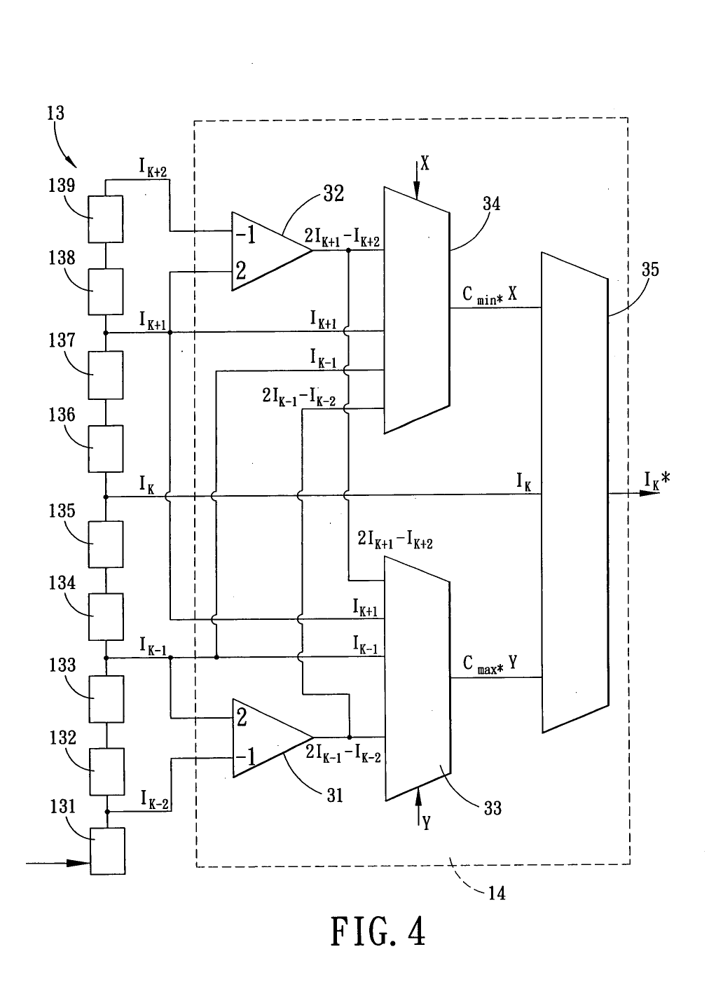

Referring to FIG. 4, in this preferred embodiment, the data buffer module 13 includes nine buffer units 131 to 139, which are primarily used to store temporarily the nine pixel values successively inputted therein in a FIFO manner.

The calculating module 14 includes first to fifth operators 31 to 35, and operates in the following manner: The first operator 31 receives the pixel values Iₖ₋₁, Iₖ₋₂ from the buffer units 133, 131, calculates 2*Iₖ₋₁−Iₖ₋₂, and outputs the result to the third operator 33 and the fourth operator 34.

The second operator 32 receives the pixel values Iₖ₊₁, Iₖ₊₂ from the buffer units 137, 139, calculates 2*Iₖ₊₁−Iₖ₊₂, and outputs the result to the third operator 33 and the fourth operator 34.

The third operator 33 receives the calculated value 2*Iₖ₋₁−Iₖ₋₂ from the first operator 31, the pixel value Iₖ₋₁ from the buffer unit 133, the pixel value Iₖ₊₁ from the buffer unit 137, and the calculated value 2*Iₖ₊₁−Iₖ₊₂ from the second operator 32, altogether four values. The third operator 33 calculates to obtain the maximum value of the four values: (Iₖ₋₁, 2*Iₖ₋₁−Iₖ₋₂, 2*Iₖ₊₁−Iₖ₊₂, Iₖ₊₁)=cmax, multiplies cmax by a parameter Y, and outputs the result Y*cmax to the fifth operator 35.

The fourth operator 34 is similar to the third operator 33, and receives the calculated value 2*Iₖ₋₁−Iₖ₋₂ from the first operator 31, the pixel value Iₖ₋₁ from the buffer unit 133, the pixel value Iₖ₊₁ from the buffer unit 137, and the calculated value 2*Iₖ₊₁−Iₖ₊₂ from the second operator 32. Unlike the third operator 33, the fourth operator 34 calculates to obtain the minimum value of the four values (Iₖ₋₁, 2*Iₖ₋₁−Iₖ₋₂, 2*Iₖ₊₁−Iₖ₊₂, Iₖ₊₁)=cmin, multiplies cmin by a parameter X, and outputs the result X*cmin to the fifth operator 35.

It should be noted that the parameters X and Y are used as empirical values for fine-tuning, and respectively cover the following ranges:

Xε{0.5, 0.25, 0.125, 0.875, 1}; and

Yε{1, 1.5, 1.25, 1.125, 1.875}.

Finally, the fifth operator 35 receives the calculated value cmax*Y outputted by the third operator 33, the target pixel value Iₖ, and the calculated value X*cmin outputted by the fourth operator 34, altogether three values. The fifth operator 35 calculates a processing value Iₖ*=median value of (X*cmin, Iₖ, cmax*Y), i.e., obtaining a median value of the three values so as to reduce the difference between the processing value Iₖ* and adjacent pixel values.

If the target pixel value Iₖ is equal to the processing value Iₖ*, this indicates absence of pixel defect and hence no need for compensation. If the target pixel value Iₖ is not equal to the processing value Iₖ*, this indicates pixel defect, and the target pixel value Iₖ is replaced by the processing value Iₖ*.

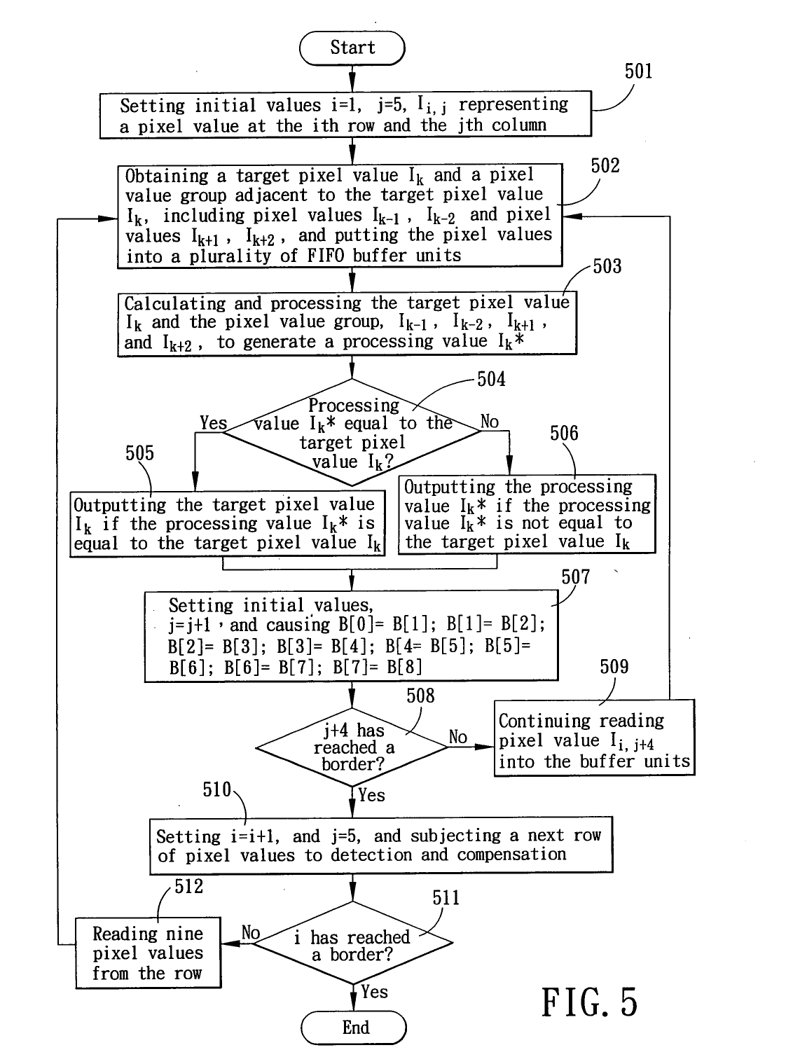

Referring to FIGS. 2, 3 and 5, the processing method for automatically detecting and compensating pixel defects of this invention includes the following steps:

In step 501, initial values are set: i=1 and j=5; I_{i,j} representing a pixel value at the i^{th} row and the j^{th} column.

In step 502, j is set to be equal to k, and a target pixel value Iₖ and a pixel value group adjacent to the target pixel value Iₖ, which includes pixel values Iₖ₋₁, Iₖ₋₂ and pixel values Iₖ₊₁, Iₖ₊₂, are obtained. The pixel values are subsequently put into a plurality of buffer units B[j] in a FIFO manner so that Iₖ=B[4], Iₖ₋₁=B[2], Iₖ₋₂=B[0], Iₖ₊₁=B[6], and Iₖ₊₂=B[8].

In step 503, the target pixel value Iₖ and the pixel value group, Iₖ₋₁, Iₖ₋₂, Iₖ₊₁, and Iₖ₊₂, are calculated and processed to generate a processing value Iₖ*. The processing value Iₖ* is calculated using the following Equations 1 to 3:

cmin=minimum value of (Iₖ₋₁,2*Iₖ₋₁−Iₖ₋₂,2*Iₖ₊₁−Iₖ₊₂,Iₖ₊₁) Equation 1

cmax=maximum value of (Iₖ₋₁,2*Iₖ₋₁−Iₖ₋₂,2*Iₖ₊₁−Iₖ₊₂,Iₖ₊₁) Equation 2

Iₖ*=median value of (X*cmin,Iₖ,cmax*Y) Equation 3

In step 504, it is determined whether the processing value Iₖ* is equal to the target pixel value Iₖ. If the processing value Iₖ* is equal to the target pixel value Iₖ, the target pixel value Iₖ is outputted in step 505. If the processing value Iₖ* is not equal to the target pixel value Iₖ, the processing value Iₖ* is outputted in step 506.

Subsequently, in step 507, a next target pixel value Iₖ is processed, an initial value j is set to be equal to j+1, and the following settings are made: B[0]=B[1]B[1]=B[2]; B[2]=B[3]; B[3]=B[4]; B[4=B[5]; B[5]=B[6]; B[6]=B[7]; and B[7]=B[8].

In step 508, it is determined whether j+4 has reached a border J of the matrix. If negative, the pixel value I_{i,j+4} is read into the aforesaid buffer units in step 509, and the flow returns to step 502. If affirmative, in step 510, i is set to be equal to i+1, and j is set to be equal to 5. This indicates that a next row of pixel values is subjected to detection and compensation. In step 511, it is determined whether i has reached a border I of the matrix. If negative, in step 512, reading of nine pixel values is continued, and the flow returns to step 502. If affirmative, this indicates that detection and compensation have been conducted with respect to all of the pixel values, and the flow is ended.

In sum, since a processing value Iₖ* is generated by calculating and processing a target pixel value Iₖ and pixel values Iₖ₋₁, Iₖ₋₂, Iₖ₊₁ and Iₖ₊₂ neighboring the target pixel value Iₖ in the present invention, operation can proceed using a relatively small amount of buffer space, i.e., nine buffer units 131-139. Furthermore, since the target pixel value Iₖ is outputted if the processing value Iₖ* is equal to the target pixel value Iₖ, and since the processing value Iₖ* is outputted if the processing value Iₖ* is not equal to the target pixel value Iₖ, pixel defects can be immediately detected and compensated when outputting the pixel values.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A processing circuit for automatic detection and compensation of pixel defects, comprising:
a reading unit adapted to read pixel values of a predetermined number of pixels, the pixel values including a target pixel value and a pixel value group adjacent to the target pixel value;
a data buffer module coupled to said reading unit, receiving the pixel values outputted from said reading unit and storing the pixel values received thereby temporarily in a first-in-first-out manner; and
a calculating module coupled to said data buffer module for calculating and processing the target pixel value and the pixel value group from said data buffer module to generate a processing value, the target pixel value being outputted if the processing value is equal to the target pixel value, the processing value being outputted if the processing value is not equal to the target pixel value.

2. The processing circuit according to claim 1, wherein said data buffer module includes a plurality of buffer units, each of said buffer units storing the pixel values temporarily.

3. The processing circuit according to claim 1, wherein the pixel values of the predetermined number of pixels include a row of nine pixel values, which include a target pixel value Iₖ in the middle, four pixel values on the left side of the target pixel value Iₖ, and four pixel values on the right side of the target pixel value Iₖ, Iₖ₋₁ representing the pixel value of a pixel of the same color on the left side and closest to the target pixel value Iₖ, Iₖ₋₂ representing the pixel value of a pixel of the same color on the left side of and closest to the pixel value Iₖ₋₁, Iₖ₊₁ representing the pixel value of a pixel of the same color on the right side of the target pixel value Iₖ, Iₖ₊₂ representing the pixel value of a pixel of the same color on the right side of and closest to the pixel value Iₖ₊₁.

4. The processing circuit according to claim 3, wherein said calculating module calculates the processing value Iₖ* using the following equations:
cmin=minimum value of (Iₖ₋₁,2*Iₖ₋₁−Iₖ₋₂,2*Iₖ₊₁−Iₖ₊₂,Iₖ₊₁)
cmax=maximum value of (Iₖ₋₁,2*Iₖ₋₁−Iₖ₋₂,2*Iₖ₊₁−Iₖ₊₂,Iₖ₊₁)
Iₖ*=median value of (X*cmin,Iₖ,cmax*Y)
where parameters X and Y are empirical values for fine tuning.

5. The processing circuit according to claim 4, wherein the parameters X and Y respectively cover the following ranges:
Xε{0.5, 0.25, 0.125, 0.875, 1}; and
Yε{1, 1.5, 1.25, 1.125, 1.875}.

6. A processing method for automatically detecting and compensating pixel defects, comprising the following steps:
(A) obtaining a target pixel value Iₖ and a pixel value group located adjacent to the target pixel value Iₖ and including pixel values Iₖ₋₁, Iₖ₋₂ and Iₖ₊₁, Iₖ₊₂, and putting the pixel values respectively in a plurality of first-in-first-out buffer units;
(B) calculating and processing the target pixel value Iₖ and the pixel values Iₖ₋₁, Iₖ₋₂, Iₖ₊₁, and Iₖ₊₂ of the pixel value group so as to generate a processing value Iₖ*; and
(C) determining whether the processing value Iₖ* is equal to the target pixel value Iₖ, the target pixel value Iₖ being outputted if affirmative, the processing value Iₖ* being outputted if negative.

7. The processing method according to claim 6, wherein initial values of i and j are preset to be equal to 1 and 5, respectively, I_{i,j} representing value of a pixel at the i^{th} row and the j^{th} column, said processing method further comprising the following steps:
(D) prior to processing a next target pixel value, determining whether a (j+4)^{th} column to be processed has reached a border, the next target pixel value I_{i,j+4} being read into the buffer units if negative, detection and compensation being performed on a next row of pixel values and i and j are respectively set to be equal to i+1 and 5 if affirmative; and
(E) determining whether i has reached a border, nine pixel values being read from said next row of pixel values and the flow returning to step (A) if negative, the flow being ended if affirmative.

8. The processing method according to claim 6, wherein the processing value Iₖ* is calculated according to the following equations:
cmin=minimum value of (Iₖ₋₁,2*Iₖ₋₁−Iₖ₋₂,2*Iₖ₊₁−Iₖ₊₂,Iₖ₊₁)
cmax=maximum value of (Iₖ₋₁,2*Iₖ₋₁−Iₖ₋₂,2*Iₖ₊₁−Iₖ₊₂,Iₖ₊₁)
Iₖ*=median value of (X*cmin,Iₖ,cmax*Y)
where parameters X and Y are empirical values for fine tuning.

9. The processing method according to claim 8, wherein the parameters X and Y respectively cover the following ranges:
Xε{0.5, 0.25, 0.125, 0.875, 1}; and
Yε{1, 1.5, 1.25, 1.125, 1.875}.
